(19) United States
(12) Patent Application Publication
(10) Pub. No.: US 2008/0148595 A1
(43) Pub. Date: Jun. 26, 2008

(54) Method and apparatus for drying substrates using a surface tensions reducing gas

(75) Inventors: John M. de Larios, Palo Alto, CA (US); Paul A. Kittle, West Chester, PA (US); Michael Ravkin, Sunnyvale, CA (US); Mikhail Korolik, San Jose, CA (US); Erik Freer, Campbell, CA (US); Katrina Mikhaylich, San Jose, CA (US); Fritz C. Redeker, Fremont, CA (US)

Correspondence Address: MARTINE PENILLA & GENCARELLA, LLP, 710 LAKEWAY DRIVE, SUITE 200, SUNNYVALE, CA, 94085, US

(73) Assignee: Lam Research Corporation, Fremont, CA (US)

(21) Appl. No.: 11/643,479

(22) Filed: Dec. 20, 2006

(51) Int. Cl. F26B 7/00; F26B 21/00

(52) U.S. Cl. 34/448; 34/329; 34/427; 34/548; 34/588

(57) ABSTRACT

A method for processing a substrate using a proximity head is disclosed. The method is initiated by, providing a head with a head surface positioned proximate to a surface of the substrate. The head has a width and a length, and the head has a plurality of ports that are configured in rows along the length of the head. The plurality of rows can extend over a width of the head, and there is a first group of ports configured to dispense a first fluid. The first fluid is dispensed to the surface of the substrate forming a meniscus between the surface of the substrate and the surface of the head. The method also includes delivering gaseous carbon dioxide from a second group of ports of the head to an interface between the meniscus and the substrate. The carbon dioxide assists in promoting a reduced surface tension on the meniscus relative to surface of the substrate.

### BACKGROUND OF THE INVENTION

1. Field of the Invention

The present invention relates generally to substrate processing and equipment, and more particularly to systems that dry semiconductor substrates using a surface tension reducing gas.

2. Description of the Related Art

In the semiconductor chip fabrication process, it is well-known that there is a need to clean and dry a wafer where a fabrication operation has been performed that leaves unwanted residues on the surfaces of wafers. Examples of such a fabrication operation include plasma etching and chemical mechanical polishing (CMP). In CMP, a wafer is placed in a holder that pushes a wafer surface against a polishing surface. A slurry consists of chemicals and abrasive materials to cause the polishing. Unfortunately, this process tends to leave an accumulation of slurry particles and residues at the wafer surface. If left on the wafer, the unwanted residual material and particles may cause, among other things, defects such as scratches on the wafer surface and inappropriate interactions between metallization features. In some cases, such defects may cause devices on the wafer to become inoperable. In order to avoid the undue costs of discarding wafers having inoperable devices, it is therefore necessary to clean the wafer adequately yet efficiently after fabrication operations that leave unwanted residues.

After a wafer has been wet cleaned, the wafer must be dried effectively to prevent water or cleaning fluid remnants from leaving residues on the wafer. If the cleaning fluid on the wafer surface is allowed to evaporate, as usually happens when droplets form, residues or contaminants previously dissolved in the cleaning fluid will remain on the wafer surface after evaporation (e.g., and form spots). To prevent evaporation from taking place, the cleaning fluid must be removed as quickly as possible without the formation of droplets on the wafer surface.

In an attempt to accomplish this, one of several different drying techniques is employed, such as spin-drying and the like. These drying techniques utilize some form of a moving liquid/gas interface on a wafer surface that, if properly maintained, results in drying of a wafer surface without the formation of droplets. Unfortunately, if the moving liquid/gas interface breaks down, as often happens with all of the aforementioned drying methods, droplets form and evaporation occurs resulting in contaminants and/or spots being left on the wafer surface.

In view of the forgoing, there is a need for drying technique that minimizes the effects of droplets on the surface of the substrate.

### SUMMARY

In one embodiment, a method for processing a substrate using a proximity head is disclosed. The method is initiated by, providing a head with a head surface positioned proximate to a surface of the substrate. The head has a width and a length, and the head has a plurality of ports that are configured in rows along the length of the head. The plurality of rows can extend over a width of the head, and there is a first group of ports configured to dispense a first fluid. The first fluid is dispensed to the surface of the substrate forming a meniscus between the surface of the substrate and the surface of the head. The method also includes delivering gaseous carbon dioxide from a second group of ports of the head to an interface between the meniscus and the substrate. The carbon dioxide assists in promoting a reduced surface tension on the meniscus relative to surface of the substrate.

In another embodiment, a second method for processing a substrate is disclosed. The method begins by applying a process fluid to a surface of the substrate. The process fluid forms a meniscus between a head and the surface of the substrate, the meniscus has an interface defined by the process fluid and the substrate. The method continues by applying a carbon dioxide gas flow in a directed orientation toward the interface of the meniscus. The carbon dioxide can partially mix with the meniscus at the interface so as to aid in reducing a surface tension of the meniscus over the surface of the substrate. The method continues as the meniscus is moved relative to the surface of the substrate while applying the process fluid and the carbon dioxide gas so the meniscus remains substantially intact during the movement. Wherein the application of the carbon dioxide gas is calibrated to deliver a flow that enables the moving of the meniscus at a set speed.

In yet another embodiment, a proximity system for processing a substrate, is disclosed. The proximity system includes a head with a head surface configured to be positioned proximate to a surface of the substrate. The head includes a first plurality of ports configured to deliver a fluid to the surface of the substrate. When the fluid is delivered a meniscus is capable of being forming between the surface of the substrate and the head surface. The proximity system also includes a second plurality of ports being configured to deliver gaseous carbon dioxide. The gaseous carbon dioxide is delivered to an interface between the meniscus and the substrate, wherein the carbon dioxide produces a Marangoni effect on the meniscus.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1 is a high level schematic of a process module, in accordance with one embodiment of the present invention.

FIG. 2 illustrates an exemplary configuration of a proximity station, in accordance with one embodiment of the present invention.

FIG. 3A illustrates an exemplary side view of the proximity station as the substrate enters the meniscus in accordance with one embodiment of the present invention.

FIG. 3B and FIG. 3C illustrate exemplary schematics of port layouts on the surface of the head in accordance with one embodiment of the present invention.

FIG. 3D illustrates an exemplary side view of the proximity station as the substrate passes through the meniscus, in accordance with one embodiment of the present invention.

FIG. 4 illustrates a Marangoni effect between the gas dispensed from port and the meniscus, in accordance with one embodiment of the present invention.

FIG. 5 illustrates an exemplary condition where micro-droplets are formed on the surface of the substrate, in accordance with one embodiment of the present invention.

### DETAILED DESCRIPTION

An invention is disclosed for processing a substrate and more specifically, for producing a Marangoni effect using a gas, such as carbon dioxide. In embodiments of the present invention, a meniscus is applied to a surface of a substrate with a proximity head. A proximity head is an apparatus that can receive fluids, and remove fluids from a surface of a substrate, when the proximity head is placed in close relation to the surface of the substrate. In one example, the proximity head has a head surface and the head surface is placed substantially parallel to the surface of the substrate. The meniscus is thus defined between the head surface and the surface of the substrate. Different degrees of proximity are possible, and example proximity distances may be between about 0.2 mm and about 4 mm, and in another embodiment between about 0.3 mm and about 1.5 mm.

The proximity head, in one embodiment, will receive a plurality of fluid inputs and is also configured with vacuum ports for removing the fluids that were provided. A “meniscus”, as used herein, is a controlled fluid meniscus that forms between the surface of a proximity head and a substrate surface, and surface tension of the fluid holds the meniscus in place and in a controlled form. Controlling the meniscus is also ensured by the controlled delivery and removal of fluid, which enables the controlled definition of the meniscus, as defined by the fluid. The meniscus may be used to either clean, process, etch, or process the surface of the substrate. The processing on the surface may be such that particulates or unwanted materials are removed by the meniscus. In a related embodiment, the meniscus may be formed out of a tri-state body (e.g., a foamed solution), and the solution may simply sit on the surface at the substrate, but mechanically function different than fluid solutions that are affected by surface tension. A foamed solution behaves more like a non-Newtonian fluid.

A “substrate,” as an example used herein, denotes without limitation, semiconductor wafers, hard drive disks, optical discs, glass substrates, and flat panel display surfaces, liquid crystal display surfaces, etc., which may become contaminated during manufacturing or handling operations. Depending on the actual substrate, a surface may become contaminated in different ways, and the acceptable level of contamination is defined in the particular industry in which the substrate is handled.

In one embodiment, the fluid delivery to the proximity head is dynamically configurable, such that dispensing and removing of process fluids (or mixtures) can be preconfigured, depending on the desired application. A programmable distribution manifold can partly assist the configuration of a proximity head. The programmable distribution manifold can define which fluids are delivered to the proximity head and can also define where on the proximity head the fluids will be delivered. The result is that the fluids can be placed on just the desired regions of the substrate, and in desired orders. For instance, different fluid can be delivered to different parts of the proximity head, so that fluids of different types can perform different processes, one after another, as the head or substrate moves.

In one example, multiple menisci can be generated, of different sizes and placement, as configured by the programmable distribution manifold. The proximity head is also provided with a plurality of ports, so that the controlled delivery and selection of regions of the proximity is facilitated, once the fluids are directed to the proximity head from the programmable distribution manifold.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

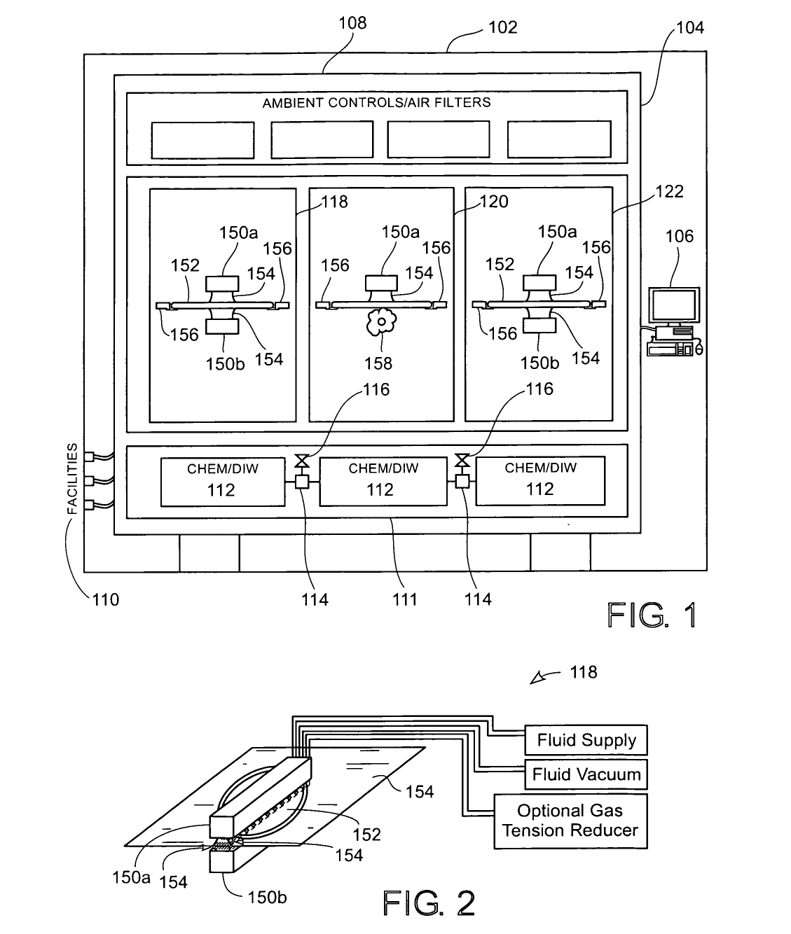

FIG. 1 is a high level schematic of a process module 104, in accordance with one embodiment of the present invention. The process module may be located in a clean room 102 and connected to a computer 106. The clean room 102 can include facilities 110 that are capable of providing fluids and gases for use within the process module 104. To control storage and application of the fluids and gases, the process module 104 can include fluid controls 111 and gas controls 108. The gas controls 108 can include air filters, gas valves, and devices to control the temperature and humidity of gases used in the process module.

In one embodiment, the fluid controls 111 can include fluid handlers 112, flow controllers 114, and valves 116. The fluid handlers 112 can be used to store process chemicals, de-ionized water, and other materials or solutions. The flow controllers 114 and valves 116 can be used to control the mixing and dispensing of fluids. Additional fluid controls 111 can include equipment that can recycle process chemicals and de-ionized water.

The process module 104 can have a single process station or multiple process stations. It should be clear that the process module 104 may contain fewer or more process stations than shown in FIG. 1. An individual process station can perform one, or a combination of processes including, but not limited to, plating, etching, rinsing, cleaning or other operations typically used in the semiconductor processing environment.

In one embodiment proximity stations 118 and 122 can contain a proximity head comprised of a head 150a and a head 150b. A meniscus 154 can be formed from a process fluid between the head 150a and the head 150b and a substrate 152, held by carrier 156, can pass through the meniscus 154. Another example of a proximity station is proximity station 120. Proximity station 120 can include carrier 156 and a head 150a that can produce a meniscus 154. A brush 158 for cleaning a surface of the substrate 152 can also be included in proximity station 120. The proximity stations shown in FIG. 1 are for exemplary purpose and should not be considered limiting in functionality nor considered to scale of actual proximity stations.

FIG. 2 illustrates an exemplary configuration of a proximity station 118, in accordance with one embodiment of the present invention. The substrate 152 is inserted into the proximity station 118 that can include a proximity head having a head 150a and a head 150b. A carrier 156 may hold and guide the substrate 152 between the head 150a and the head 150b. In one embodiment, the meniscus 154 is initially formed between the head 150a and the head 150b In another embodiment, a meniscus 154 is allowed to form between a surface of the head 150a and a surface of the substrate 152 (and surfaces of the carrier 156). The meniscus 154 is a controlled fluid meniscus that can form between the surface of a proximity head 150a and the substrate surface, and surface tension of the fluid holds the meniscus 154 in place and in a controlled form. Controlling delivery and removal of a meniscus fluid may also ensure further control of the meniscus 154. The meniscus 154 may be used to clean, process, etch, or process the surface of the substrate 152.

The meniscus 154 is constrained within the proximity station by supplying the meniscus fluid to the head 150a and the head 150b by removing the meniscus fluid with a vacuum in a controlled manner. Optionally, a gas tension reducer may be provided to the proximity heads 150a, so as to reduce the surface tension between the meniscus 154 and the substrate 152. The gas tension reducer supplied to the proximity heads 150a and 150b allows the meniscus 154 to move over the surface of the substrate 152 at an increased speed (thus increasing throughput). Examples of a gas tension reducer may be isopropyl alcohol mixed with nitrogen (IPA/N₂). Another example of a gas tension reducer may be carbon dioxide (CO₂). Other types of gasses may also be used so long as the gasses do not interfere with the processing desired for the particular surface of the substrate 152.

The embodiment shown in FIG. 2 is shown connected to a single fluid supply. It should be understood that other embodiments of a proximity head can include multiple fluid supplies and multiple varieties of gas for tension reduction. Such an embodiment may enable a single proximity head to apply and remove multiple process fluids. Further, for completeness, it should be understood that the proximity station can be in any orientation, and as such, the meniscus 154 can be applied to surfaces that are not horizontal (e.g., vertical substrates or substrates that are held at an angle).

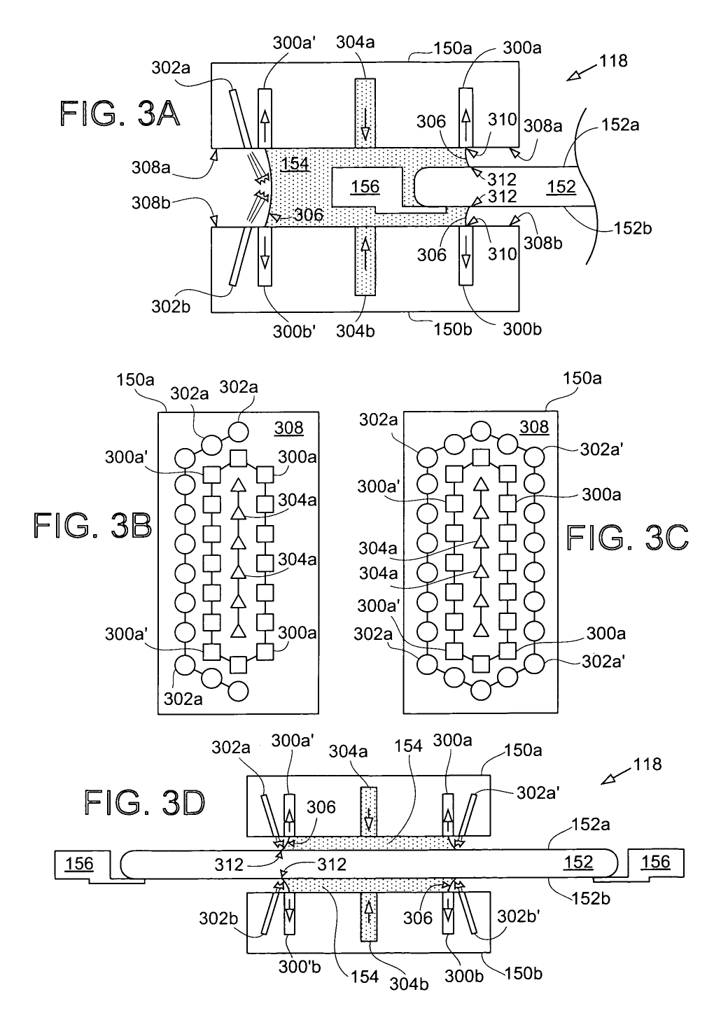

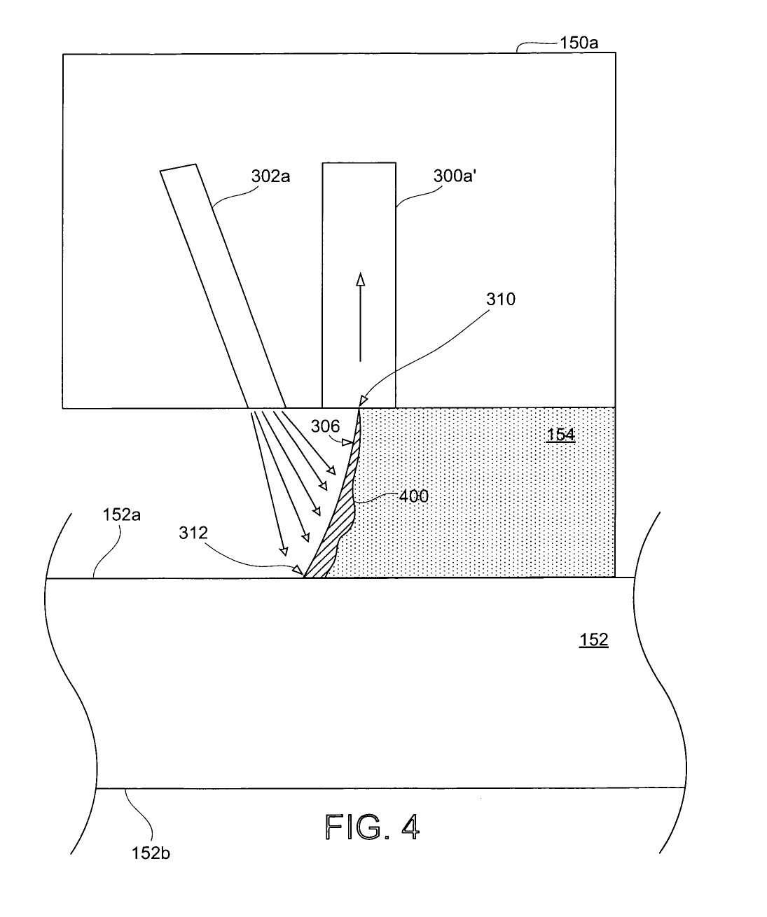

FIG. 3A illustrates an exemplary side view of the proximity station 118 as the substrate 152 enters the meniscus 154 in accordance with one embodiment of the present invention. The meniscus 154 can be initially established between head 150a and 150b by supplying a fluid using meniscus supply port 304a and meniscus supply port 304b. The formation of the meniscus 154 creates meniscus/head boundaries 310 where a boundary 306 of the meniscus 154 is in contact with a surface 308a of the head 150a or a surface 308b of the head 150b. As the carrier 156 moves the substrate 152 between the head 150a and head 150b, the substrate 152 encounters vacuum ports 300a/300a′ and 300b/300b′. In one embodiment, the vacuum ports 300a/300a′ and 300b/300b′ are configured to remove fluids from the meniscus 154, but also assist in removing any contaminants, particles or unwanted material from the surface of the substrate 152. By carefully controlling a vacuum rate of the vacuum ports 300a/300a′ and 300b/300b′, it is possible to ensure that the meniscus 154 is held between the surface 308a of the head 150a and the surface 308b of the head 150b.

After passing under the vacuum ports 300a and 300b, the carrier 156 and the substrate 152 enter the meniscus 154. As the carrier 156 and the substrate 152 enter the meniscus 154, meniscus/surface boundaries 312 are formed at an interface between the boundary 306 of the meniscus 154 and a surface 152a or a surface 152b of the substrate 152. By using the vacuum techniques described above, and by controlling the input of meniscus fluid through the meniscus supply ports 304a and 304b, the meniscus 154 can remain stable as meniscus fluid is displaced by the carrier 156 and the substrate 152.

As shown in FIG. 3A, gas ports 302a and 302b, capable of dispensing the gas tension reducer, are positioned to the left of vacuum port 300a′ and 300b′ respectively. As previously discussed, the gas tension reducer can reduce the surface tension between the meniscus 154 and the substrate 152. The gas can also be used in conjunction with the vacuum ports 300a′ and 300b′ to assist in containing the meniscus 154 within the heads 150a and 150b. Additional benefits and effects of the gas on the boundary 306 will be discussed in FIG. 3D. In other embodiments, additional gas ports may be positioned to the right of vacuum ports 300a and 300b as shown in FIG. 3D. Note, the gas ports 300a′/300a and 302a′/302a, as illustrated in FIG. 3A and FIG. 3D, are shown angled toward the meniscus 154. The angle shown is exemplary and should not be considered limiting as angles of the gas ports can vary depending on a particular application.

FIG. 3B and FIG. 3C illustrate exemplary schematics of port layouts on the surface 308a of the head 150a in accordance with one embodiment of the present invention. FIG. 3B illustrates the bottom view of head 150a from FIG. 3A where vacuum ports 300a are followed by meniscus supply ports 304a. Following the meniscus supply ports 304a are vacuum ports 300a′ and gas ports 302a. FIG. 3C illustrates an embodiment of a head 150a where gas ports 302a′/302a surround the vacuum ports 300a/300a′. Also illustrated in FIG. 3C are the vacuum ports 300a/300a′ surrounding the meniscus supply ports 304a. Note, in FIG. 3B and FIG. 3C, openings to the vacuum ports 300a/300a′ and meniscus supply ports 304a are shown as squares and triangles respectively. The various shapes of port openings were made in an effort to help differentiate the types of ports within the figures. It should be understood that port openings can be made in a variety of shapes, and what is shown in FIG. 3B and FIG. 3C, should not be considered limiting.

FIG. 3D illustrates an exemplary side view of the proximity station 118 as the substrate 152 passes through the meniscus 154, in accordance with one embodiment of the present invention. As the carrier 156 and the substrate 152 exit the meniscus 154, ports 302a and 302b are used to dispense a flow of gas tension reducer to the meniscus/surface boundary 312. In one embodiment, the gas tension reducer can be gaseous CO₂ that can be supplied to the ports 302a and 302b under pressure, or simply delivered to ports 302a and 302b so that CO₂ flows out and is present near the boundary 306. If pressurized, the CO₂ flow may be delivered at a pressure of between about 5 psi and about 60 psi. In one example, the CO₂ can be diluted with inert gases or can be applied as pure CO₂. In one embodiment, the flow of CO₂ is at least equivalent to the flow of other tension reducing gases, such as an IPA/N₂ mixture, and in other embodiments, the flow of CO₂ can be more. In still another example, the flow of CO₂ from each of ports 302a and ports 302b is in a range between about 1.1 to about 1.8 times the a flow that may be provided when anIPA/N₂ mixture is used. When an IPA/N₂ mixture is used, the flow is calibrated for the specific application, the type of fluids being applied, the speed of the substrate relative to the meniscus 154, and other factors. In a more general sense, the flow of CO₂ should be configured to increase if the relative speed of the meniscus moving over the substrate is desired to be increased (e.g., to increase throughput, etc.).

The gas tension reducer, in one embodiment CO₂, is provided to promote a type of Marangoni effect on the fluids of the meniscus 154. A Marangoni effect is the mass transfer on, or in, a liquid layer due to difference in surface tension. Since a liquid with a high surface tension pulls more strongly on the surrounding liquid than one with a low surface tension, the presence of a gradient in surface tension will cause the liquid to flow away from regions of low surface tension. In the defined embodiments, dispensing of CO₂ gas assists in reducing the surface tension at the meniscus/surface boundary 312 at the surface 152a of the substrate 152. By lowering the surface tension of the meniscus/surface boundary 312 relative to the surface of the substrate 152, it is possible to move or traverse the meniscus 154 along the surface of the substrate 156 at faster rates, and minimizing (or eliminate) traces of the fluids, droplets or staining from dried fluid droplets or beads.

In one embodiment, the heads 150a and 150b remain stationary while the carrier 156 and the substrate 154 move through the meniscus 154 at a speed between about 10 mm/second and about 40 mm/second. In another embodiment, the heads 150a and 150b and the meniscus 154 can move while the carrier 156 and the substrate 152 remain stationary. In yet another embodiment, heads 150a and 150b and the substrate 152 can be moving with a relative speed of the substrate 152 to the heads 150a and 150b being a speed between about 10 mm/second and about 40 mm/second.

Using CO2 to produce the Marangoni effect provides additional benefits including, but not limited to, reduced flammability compared to other gases or gas mixtures that can produce the Marangoni effect. The inert nature of CO₂ can reduce flammability of the gas dispensed by gas ports 302a/302a′ and 302b/302b′. The reduction in flammability can allow for a reduction in fire suppression equipment, thereby simplifying and reducing costs associated with designing, building and maintaining proximity stations. Additional simplification and cost reduction can be realized by using CO₂ because gaseous CO₂ is readily available and may not require processing, such as vaporization and saturation, before being supplied to the heads 150a and 150b.

Additionally, after exposure to CO₂, there may be very little change to the meniscus fluid, thus simplifying recycling of the meniscus fluid when compared to the recycling of meniscus fluids that are exposed to other various gases. Gases other than CO₂ can include vaporized additives. After the meniscus fluid is repeatedly exposed to the gases, the vaporized additives can condense within the meniscus fluid and eventually alter the properties of the meniscus fluid. Failure to remove the condensed additives can result in undesirable processing characteristics including, but not limited to, decreased efficacy of the meniscus fluid. As the condensed additives may be thoroughly mixed and integrated into the meniscus fluid, additional equipment and process steps necessary to remove the condensed additive complicating recycling of the meniscus fluid. Using CO₂, changes to the meniscus fluid can be minimized and controlled by careful selection of the meniscus fluid. Additionally, because CO2 does not introduce an additive to the meniscus fluid that must be removed, costs associated with designing, implementing and operating recycling equipment can be reduced.

FIG. 4 illustrates a Marangoni effect between the gas dispensed from port 302a and the meniscus 154, in accordance with one embodiment of the present invention. For simplicity, the meniscus/surface boundary 312 between the meniscus 154 and the surface 152 of the substrate 152 is shown. A surface tension gradient 400 along the surface of the meniscus, created by the gas dispensed from the port 302a, is shown from the meniscus/surface boundary 312 to the boundary 306. The gas from port 302a, along with the meniscus fluid delivered from the meniscus supply port, mix in such a manner that the gas and the meniscus fluid mixture decreases the tension at the boundary 312 creating a relatively higher surface tension at the boundary 306. Higher tension along the boundary 306 relative to the meniscus/surface boundary 312 produces the Marangoni effect where fluid with a lower surface tension is pulled toward fluid with a higher surface tension. The result is fluid from the meniscus/surface boundary 312 being drawn toward the bulk of the meniscus 154 resulting in the substrate 152 being substantially dry after passing under gas port 302a.

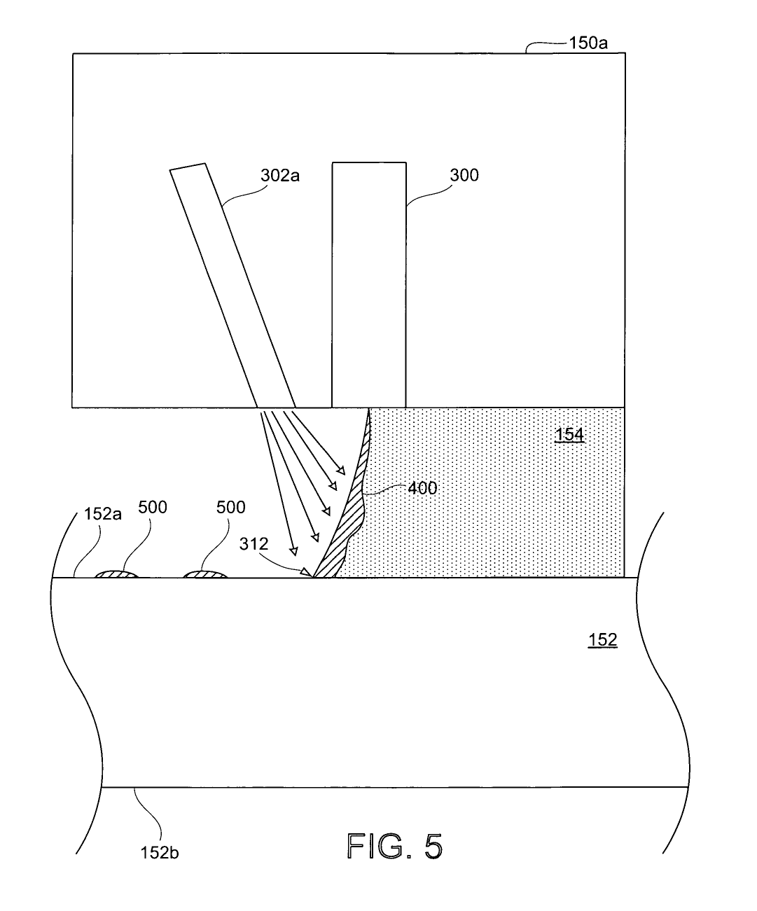

FIG. 5 illustrates an exemplary condition where micro-droplets 500 are formed on the surface 152a of the substrate 152, in accordance with one embodiment of the present invention. After the substrate 152 passes under gas port 302a it is possible for micro-droplets 500 of meniscus fluid to remain on the surface of the substrate 152. While generally undesirable, the micro-droplets 500 can be formed when the meniscus/surface boundary 312 breaks leaving a micro-droplet 500 of meniscus fluid on the surface 152a of the substrate 152. It should be understood that micro-droplets 500 can be extremely small and can evaporate almost instantaneously after breaking away from the meniscus 154. Micro-droplets 500 are undesirable because the micro-droplets 500 can contain a minute amount of potential contaminant material. After evaporation of the micro-droplet 500, the contaminant material can be deposited on the surface 152a of the substrate 152.

In one embodiment, dispensing of CO₂ from port 302a can alter the pH of the fluid of the meniscus 154 and result in a decreased amount of a contaminant such as silicic acid in the micro-droplets 500. As the substrate 152 passes under the port 302a, the meniscus fluid at the meniscus/surface boundary 312 is exposed to, and can become saturated with, CO₂. In one embodiment, saturating the meniscus fluid at the meniscus/fluid boundary 312 can lower the pH of the meniscus fluid. The lowered pH at the meniscus/fluid boundary 312, can result in a reduction in the formation of silicic acid (H₂SiO₃). Thus, if a micro-droplet 500 is formed and evaporates, the reduction in silicic acid caused by exposure to CO2 can result in a reduction of trace contaminant material on the surface 152a of the substrate 152.

In other embodiments, to achieve a desired change in the meniscus fluid after exposure to the gas tension reducer, an additive sensitive to the gas tension reducer may be added to the meniscus fluid. In an embodiment that uses CO₂ as the gas tension reducer and the desired change is a reduction in the formation of silicic acid, a surfactant can be added to the meniscus fluid. Examples of surfactants that are CO₂ sensitive and can reduce in formation of silicic acid include, but are not limited to, amide oxides such as: dodecyldimethylamine oxide (DDMAO), trimethylamine oxide (TMAO), N,N-dimethyl-N-dodecyl amine oxide, N,N-dimethyl-N-tetradecyl amine oxide, N,N-dimethyl-N-hexadecyl amine oxide, N,N-dimethyl-N-octadecyl amine oxide, N,N-dimethyl-N-(Z-9-octadecenyl)-N-amine oxide, N-dodecyl-N,N-dimethyl glycine, phosphates, phosphites, phosphonates, lecithins, phosphate esters, phospatidylethanolamines, phosphatidylcholines, phosphatidyl serines, phosphatidylinositols, and B′-O-lysylphosphatidylglycerols.

While the change in pH caused by exposure to CO₂ may be limited to the boundary 306 of the meniscus 154, repeated exposure may eventually adversely affect the meniscus fluid. However, it is still possible to recycle the meniscus fluid by using recycling equipment capable of monitoring and adjusting the pH of the recycled meniscus fluid.

The dispensing of CO₂, and operation of the proximity head may be controlled in an automated way using computer control. Thus, aspects of the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, such as the carrier network discussed above, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. Examples of the computer readable medium include hard drives, Network Attached Storage (NAS), read-only memory, random-access memory, CD-ROMS, CD-Rs, CD-RWS, DVDS, Flash, magnetic tapes, and other optical and non-optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

For more information on the formation of a meniscus and the application to the meniscus to a surface of a substrate, reference may be made to: (1) U.S. Pat. No. 6,616,772, issued on Sep. 9, 2003 and entitled “METHODS FOR WAFER PROXIMITY CLEANING AND DRYING”; (2) U.S. patent application Ser. No. 10/330,843, filed on Dec. 24, 2002 and entitled “MENISCUS, VACUUM, IPA VAPOR, DRYING MANIFOLD”; (3) U.S. Pat. No. 6,998,327, issued on Jan. 24, 2005 and entitled “METHODS AND SYSTEMS FOR PROCESSING A SUBSTRATE USING A DYNAMIC LIQUID”; (4) U.S. Pat. No. 6,998,326, issued on Jan. 24, 2005 and entitled “PHOBIC BARRIER MENISCUS SEPARATION AND CONTAINMENT”; (5) U.S. Pat. No. 6,488,040, issued on Dec. 3, 2002 and entitled “CAPILLARY PROXIMITY HEADS FOR SINGLE WAFER CLEANING AND DRYING”; (6) U.S. patent application Ser. No. 10/261,839, filed on Sep. 30, 2002 and entitled “METHOD AND APPARATUS FOR DRYING SEMICONDUCTOR WAFER SURFACES USING A PLURALITY OF INLETS AND OUTLETS HELD IN CLOSE PROXIMITY TO THE WAFER”; and (7) U.S. patent application Ser. No. 10/957,092, filed on Sep. 30, 2004 and entitled “SYSTEM AND METHOD FOR MODULATING FLOW THROUGH MULTIPLE PORTS IN A PROXIMITY HEAD”; each is assigned to Lam Research Corporation, the assignee of the subject application, and each is incorporated herein by reference.

Although proximity heads were defined for the purpose of fluid delivery, the fluid may be of different types. For instance, the fluids may be for plating metallic materials. Example systems and processes for performing plating operations are described in more detail in: (1) U.S. Pat. No. 6,864,181, issued on Mar. 8, 2005; (2) U.S. patent application Ser. No. 11/014,527 filed on Dec. 15, 2004 and entitled “WAFER SUPPORT APPARATUS FOR ELECTROPLATING PROCESS AND METHOD FOR USING THE SAME”; (3) U.S. patent application Ser. No. 10/879,263, filed on Jun. 28, 2004 and entitled “METHOD AND APPARATUS FOR PLATING SEMICONDUCTOR WAFERS”; (4) U.S. patent application Ser. No. 10/879,396, filed on Jun. 28, 2004 and entitled “ELECTROPLATING HEAD AND METHOD FOR OPERATING THE SAME”; (5) U.S. patent application Ser. No. 10/882,712, filed on Jun. 30, 2004 and entitled “APPARATUS AND METHOD FOR PLATING SEMICONDUCTOR WAFERS”; (6) U.S. patent application Ser. No. 11/205,532, filed on Aug. 16, 2005, and entitled “REDUCING MECHANICAL RESONANCE AND IMPROVED DISTRIBUTION OF FLUIDS IN SMALL VOLUME PROCESSING OF SEMICONDUCTOR MATERIALS”; and (7) U.S. patent application Ser. No. 11/398,254, filed on Apr. 4, 2006, and entitled “METHODS AND APPARATUS FOR FABRICATING CONDUCTIVE FEATURES ON GLASS SUBSTRATES USED IN LIQUID CRYSTAL DISPLAYS”; each of which is herein incorporated by reference.

Other types of fluids may be non-Newtonian fluids. For additional information regarding the functionality and constituents of Newtonian and on-Newtonian fluids, reference can be made to: (1) U.S. application Ser. No. 11/174,080, filed on Jun. 30, 2005 and entitled “METHOD FOR REMOVING MATERIAL FROM SEMICONDUCTOR WAFER AND APPARATUS FOR PERFORMING THE SAME”; (2) U.S. patent application Ser. No. 11/153,957, filed on Jun. 15, 2005, and entitled “METHOD AND APPARATUS FOR CLEANING A SUBSTRATE USING NON-NEWTONIAN FLUIDS”; and (3) U.S. patent application Ser. No. 11/154,129, filed on Jun. 15, 2005, and entitled “METHOD AND APPARATUS FOR TRANSPORTING A SUBSTRATE USING NON-NEWTONIAN FLUID”; each of which is incorporated herein by reference.

Another material may be a tri-state body fluid. A tri-state body is one which includes one part gas, one part solid, and one part fluid. For additional information about the tri-state compound, reference can be made to Patent Application No. 60/755,377, filed on Dec. 30, 2005 and entitled “METHODS, COMPOSITIONS OF MATTER, AND SYSTEMS FOR PREPARING SUBSTRATE SURFACES”. This Patent Application was incorporated herein by reference.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for processing a substrate using a proximity head, comprising:
providing a head having a head surface positioned proximate to a surface of the substrate, the head has a width and a length, and the head has a plurality of ports that are configured in rows along the length of the head, the plurality of rows extending over a width of the head, a first group of ports configured to dispense a first fluid to the surface of the substrate such that a meniscus is formed between the surface of the substrate and the surface of the head; and
delivering gaseous carbon dioxide from a second group of ports of the head to an interface between the meniscus and the substrate, so that the carbon dioxide assists in promoting a reduced surface tension on the meniscus relative to surface of the substrate.

2. The method for processing a substrate as recited in claim 1, wherein the carbon dioxide lowers a pH level of the first fluid at the interface to inhibit formation of contaminants in any micro-droplets remaining on the surface of the substrate after being exposed to the meniscus.

3. The method for processing a substrate as recited in claim 1, further comprising:
adding a carbon dioxide reactive amine oxide surfactant to the first fluid to inhibit formation of silicic acid, as selected from the group consisting of dodecyldimethylamine oxide (DMAO), trimethylamine oxide (TMAO), N,N-dimethyl-N-dodecyl amine oxide, N,N-dimethyl-N-tetradecyl amine oxide, N,N-dimethyl-N-hexadecyl amine oxide, N,N-dimethyl-N-octadecyl amine oxide, N,N-dimethyl-N-(Z-9-octadecenyl)-N-amine oxide, N-dodecyl-N,N-dimethyl glycine, phosphates, phosphites, phosphonates, lecithins, phosphate esters, phospatidylethanolamines, phosphatidylcholines, phosphatidyl serines, phosphatidylinositols, or B′-O-lysylphosphatidylglycerols.

4. The method for processing a substrate as recited in claim 1, wherein the processing includes one of cleaning, etching, or depositing.

5. The method for processing a substrate as recited in claim 1, wherein computer control is used to coordinate the processing of the substrate.

6. A method for processing a substrate as recited in claim 1, wherein the carbon dioxide gas is applied from a compressed source.

7. A method for processing a substrate, comprising:
applying a process fluid to a surface of the substrate, the process fluid forming a meniscus between a head and the surface of the substrate, the meniscus having an interface defined by the process fluid and the substrate, and
applying a carbon dioxide gas flow in a directed orientation toward the interface of the meniscus, the carbon dioxide at least partially mixing with the meniscus at the interface so as to aid in reducing a surface tension of the meniscus over the surface of the substrate; and
moving the meniscus relative to the surface of the substrate while applying the process fluid and the carbon dioxide gas, the meniscus remaining substantially intact during the moving;
wherein the applying of the carbon dioxide gas is calibrated to deliver a flow that enables the moving of the meniscus at a set speed.

8. A method for processing a substrate as recited in claim 7, wherein the set speed is defined to reduce formation of micro-droplets over the surface of the substrate in regions that were exposed to the meniscus when moved.

9. A method for processing a substrate as recited in claim 8, wherein the carbon dioxide lowers a pH level of the process fluid at the interface to inhibit formation of contaminants in any micro-droplets remaining on the surface of the substrate after being exposed to the meniscus.

10. A method for processing a substrate as recited in claim 7, wherein the carbon dioxide gas is applied from a compressed source.

11. The method for processing a substrate as recited in claim 7, further comprising:
adding an amine oxide surfactant to the process fluid that is pH sensitive when exposed to the carbon-dioxide gas.

12. A method for processing a substrate as recited in recited in claim 11, wherein the amine oxide surfactant as selected from the group consisting of dodecyldimethylamine oxide (DDMAO), trimethylamine oxide (TMAO), N,N-dimethyl-N-dodecyl amine oxide, N,N-dimethyl-N-tetradecyl amine oxide, N,N-dimethyl-N-hexadecyl amine oxide, N,N-dimethyl-N-octadecyl amine oxide, N,N-dimethyl-N-(Z-9-octadecenyl)-N-amine oxide, N-dodecyl-N,N-dimethyl glycine, phosphates, phosphites, phosphonates, lecithins, phosphate esters, phospatidylethanolamines, phosphatidylcholines, phosphatidyl serines, phosphatidylinositols, or B′-O-lysylphosphatidylglycerols.

13. The method for processing a substrate recited in claim 7, wherein the processing includes one of cleaning, etching, or depositing.

14. The method for processing a substrate as recited in claim 7, wherein computer control is used to coordinate the processing of the substrate.

15. A proximity station for processing a substrate, comprising:
a head having a head surface that is configured to be positioned proximate to a surface of the substrate, the head including,
a first plurality of ports being configured to deliver a fluid to the surface of the substrate such that a meniscus is capable of being formed between the surface of the substrate and the head surface when the fluid is delivered,
a second plurality of ports being configured to deliver gaseous carbon dioxide to an interface between the meniscus and the substrate, wherein the carbon dioxide produces a Marangoni effect on the meniscus.

16. A proximity station for processing a substrate as recited in claim 15, further comprising:
another head having a head surface that is configured to be positioned proximate to another surface of the substrate, the another head including,
a first plurality of ports being configured to deliver a fluid to the another surface of the substrate such that a meniscus is capable of being formed between the another surface of the substrate and the head surface when the fluid is delivered
another plurality of ports being configured to deliver gaseous CO₂ to an interface between the meniscus and the substrate, wherein the CO₂ produces a Marangoni effect on the meniscus.

17. A proximity station for processing a substrate as recited in claim 15, wherein the proximity station is a component within a process module.

18. A proximity station for processing a substrate as recited in claim 17, further comprising:
another proximity station;
gas controls;
fluid controls, and
a computer capable of controlling operation of proximity stations, ambient controls and fluid controls.

19. A proximity station for processing a substrate as recited in claim 18, wherein the process module is installable in a clean room.

20. A proximity station for processing a substrate as recited in claim 19, further comprising:
facilities capable of supplying process fluids to the process module.
